(19) United States
(12) Patent Application Publication
(10) Pub. No.: US 2020/0089619 A1
(43) Pub. Date: Mar. 19, 2020

(54) DATA STORAGE DEVICE AND METHOD OF DELETING NAMESPACE THEREOF

(71) Applicant: Silicon Motion, Inc., Jhubei City (TW)

(72) Inventors: Che-Wei HSU, Taichung City (TW); Hui-Ping KU, Zhubei City (TW)

(21) Appl. No.: 16/560,016

(22) Filed: Sep. 4, 2019

Related U.S. Application Data
(60) Provisional application No. 62/731,137, filed on Sep. 14, 2018.

(30) Foreign Application Priority Data
Jul. 24, 2019 (TW) 108126206

(51) Int. Cl. G06F 12/1009

(52) U.S. Cl. CPC G06F 12/1009; G06F 2212/7201

(57) ABSTRACT

A data storage device is provided. The data storage device includes: a flash memory and a memory controller. The memory controller is configured to manage a global logical-to-physical (L2P) mapping table of the flash memory, wherein the global L2P table includes a plurality of namespaces, and the namespaces correspond to a plurality of physical spaces in the flash memory. In response to the memory controller receiving a namespace-deleting command from a host, the memory controller deletes a target namespace from the namespaces and deletes a first logical-address range corresponding to the target namespace from the global L2P table. The memory controller further moves a second logical-address range corresponding to all of the namespaces subsequent to the target namespace in the global L2P mapping table to update the global L2P mapping table.

### CROSS REFERENCE TO RELATED APPLICATIONS

This application claims the benefit of U.S. Provisional Application No. 62/731,137, filed on Sep. 14, 2018. This application also claims priority of Taiwan Patent Application No. 108126206, filed on Jul. 24, 2019, the entireties of which are incorporated by reference herein.

### BACKGROUND OF THE INVENTION

### Field of the Invention

The present invention relates to data storage devices and, in particular, to a data storage device and a method of deleting a namespace thereof.

### Description of the Related Art

Flash memory devices typically include NOR flash devices and NAND flash devices. NOR flash devices are random access—a host accessing a NOR flash device can provide the device any address on its address pins and immediately retrieve data stored in that address on the device's data pins. NAND flash devices, on the other hand, are not random access but serial access. It is not possible for NAND flash devices to access any random address in the way described above. Instead, the host has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. In reality, the NAND flash device always reads complete pages from the memory cells and writes complete pages to the memory cells. After a page of data is read from the array into a buffer inside the device, the host can access the data bytes or words one by one by serially clocking them out using a strobe signal.

In addition, there are multiple namespaces in a flash memory. In the logical-to-physical mapping (L2P) table of the flash memory, each name space has a corresponding namespace mapping table. However, when a host has performed multiple namespace-deleting and namespace-creating operations, the namespace mapping tables in the L2P mapping table of the conventional data storage device may gradually become scattered, so that it is not easy for the memory controller to manage and maintain the namespace mapping tables.

Accordingly, there is demand for a data storage device and a method of deleting namespaces thereof to solve the aforementioned problem.

### BRIEF SUMMARY OF THE INVENTION

In an exemplary embodiment, a data storage device is provided. The data storage device includes: a flash memory and a memory controller. The memory controller is configured to manage a global logical-to-physical (L2P) mapping table of the flash memory, wherein the global L2P table comprises a plurality of namespaces, and the namespaces correspond to a plurality of physical spaces in the flash memory. In response to the memory controller receiving a namespace-deleting command from a host, the memory controller deletes a target namespace from the namespaces and deletes a first logical-address range corresponding to the target namespace f the global L2P table. The memory controller further moves a second logical-address range corresponding to all of the namespaces subsequent to the target namespace in the global L2P mapping table to update the global L2P mapping table.

In some embodiments, in response to the memory controller receiving an access command from the host, the memory controller calculates a logical address in the global L2P table corresponding to the access command according to a namespace identifier of one of the namespace and a corresponding access logical address indicated in the access command. After the global L2P table has been updated, in response the data storage device receiving a namespace-creating command from the host to create a first namespace, the memory controller creates the first namespace to be subsequent to the logical-address range of the last namespace in the updated global L2P table according to the namespace-creating command.

In some embodiments, the memory controller reads the global L2P mapping table from the flash memory into a volatile memory, deletes the logical-address range corresponding to the target namespace from the global L2P table stored in the volatile memory according to the namespace-deleting command, and moves forward each namespace subsequent to the target namespace in the global L2P mapping table to fill the logical-address range of the deleted target namespace to update the global L2P mapping table. The memory controller further writes the updated global L2P mapping table into the flash memory.

In another exemplary embodiment, a method of deleting a namespace for use in a data storage device is provided. The data storage device comprises a flash memory. The method includes the steps of: managing a global logical-to-physical (L2P) mapping table of the flash memory, wherein the global L2P table comprises a plurality of namespaces, and the namespaces correspond to a plurality of physical spaces in the flash memory; receiving a namespace-deleting command from a host; deleting a target namespace from the namespaces and deleting a first logical-address range corresponding to the target namespace from the global L2P table; and moving a second logical-address range corresponding to each namespace subsequent to the target namespace in the global L2P mapping table to update the global L2P mapping table.

In yet another exemplary embodiment, a data storage device is provided. The data storage device includes a flash memory and a memory controller. The memory controller is configured to manage a global logical-to-physical (L2P) mapping table of the flash memory, wherein the global L2P table comprises a plurality of namespaces, and the namespaces correspond to a plurality of physical spaces in the flash memory. In response to the memory controller receiving a namespace-deleting command from a host, the memory controller deletes a first target namespace from the namespaces and deletes a first logical-address range corresponding to the target namespace in the global L2P table. In response to the memory controller receiving a namespace-creating command from the host to create a second target namespace, the memory controller further determines whether the second target namespace can be created in the first logical-address range corresponding to the first target namespace. In response to the memory controller determining that the second target namespace cannot be created in the first logical-address range corresponding to the first target namespace, the memory controller moves a second logical-address range of each namespace subsequent to the first target namespace in the global L2P mapping table to update the global L2P mapping table, and creates the second target namespace in a remaining logical-address range in the updated global L2P mapping table.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic system in accordance with an embodiment of the invention;

FIG. 2 is a schematic diagram illustrating an access interface and flash memory dies in accordance with an embodiment of the invention;

FIG. 3 is a schematic diagram depicting connections between one access sub-interface and multiple flash memory dies according to an embodiment of the invention;

FIGS. 4A-4F are diagrams of the logical-to-physical mapping table in accordance with an embodiment of the invention.

FIG. 5 is a flow chart of a method of deleting namespaces in accordance with an embodiment of the invention; and

FIG. 6 is a flow chart of a method of creating a namespace in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

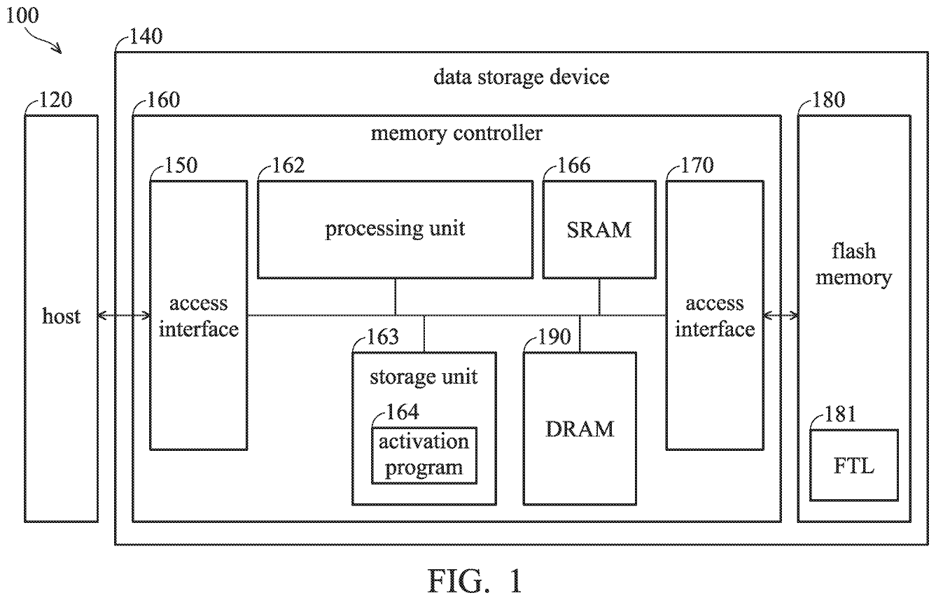

FIG. 1 is a block diagram of an electronic system in accordance with an embodiment of the invention. The electronic system 100 may be a personal computer, a data server, a network-attached storage (NAS), a portable electronic device, etc., but the invention is not limited thereto. The portable electronic device may be a laptop, a hand-held cellular phone, a smartphone, a tablet PC, a personal digital assistant (PDA), a digital camera, a digital video camera, a portable multimedia player, a personal navigation device, a handheld game console, or an e-book, but the invention is not limited thereto.

The electronic system 100 includes a host 120 and a data storage device 140. The data storage device 140 includes a memory controller 160, a flash memory 180, and a dynamic random access memory (DRAM) 190. The memory controller 160 includes a computation unit 162, a storage unit 163, and a static random-access memory (SRAM) 166. The computation unit 162 can be implemented in various manners, such as dedicated hardware circuits or general-purpose hardware (for example, a single processor, a multi-processor capable of performing parallel processing, or other processor with computation capability). For example, the computation unit 162 may be implemented by a general-purpose processor or a microcontroller, but the invention is not limited thereto. In addition, the DRAM 190 is not an essential component, and can be replaced by a host memory buffer (HMB). Generally, the size of the data storage space in the DRAM 190 is greater than that in the SRAM 166.

The processing unit 162 of the memory controller 160 may perform operations according to the command issued by the host 120 to write data to a designated address of the flash memory 180 through the access interface 170 or read data from a designated address (e.g., physical address) from the flash memory 180.

In the electronic system 100, several electrical signals are used for coordinating commands and data transfer between the computation unit 162 and the flash memory 180, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc.

The access interface 170 may communicate with the storage unit 180 using a SDR (Single Data Rate) protocol or a DDR (Double Data Rate) protocol, such as ONFI (open NAND flash interface), DDR toggle, or others. The computation unit 162 may communicate with the host 120 through an access interface 150 using a designated communication protocol, such as USB (Universal Serial Bus), ATA (Advanced Technology Attachment), SATA (Serial ATA), PCI-E (Peripheral Component Interconnect Express), NVME (Non-volatile Memory Express), or others.

The storage unit 163 may be a non-volatile memory such as a read-only memory (ROM), an erasable programmable read-only memory (EPROM), an electrically erasable programmable read-only memory (EEPROM), or an e-fuse, but the invention is not limited thereto. The storage unit 163 may store an activation program 164. The activation program may include boot code or a boot loader that is executed by the processing unit 162, and the controller 160 may be booted up based on the activation program 164 to control operations of the flash memory 180, such as reading in-system programming (ISP) code.

The flash memory 180, for example, may be a NAND flash memory, and the flash memory 180 may include a plurality of storage sub-units, where each storage sub-unit can be implemented by a flash memory die or a logical unit number (LUN) which may communicate with the processing unit 162 using the corresponding storage sub-interface.

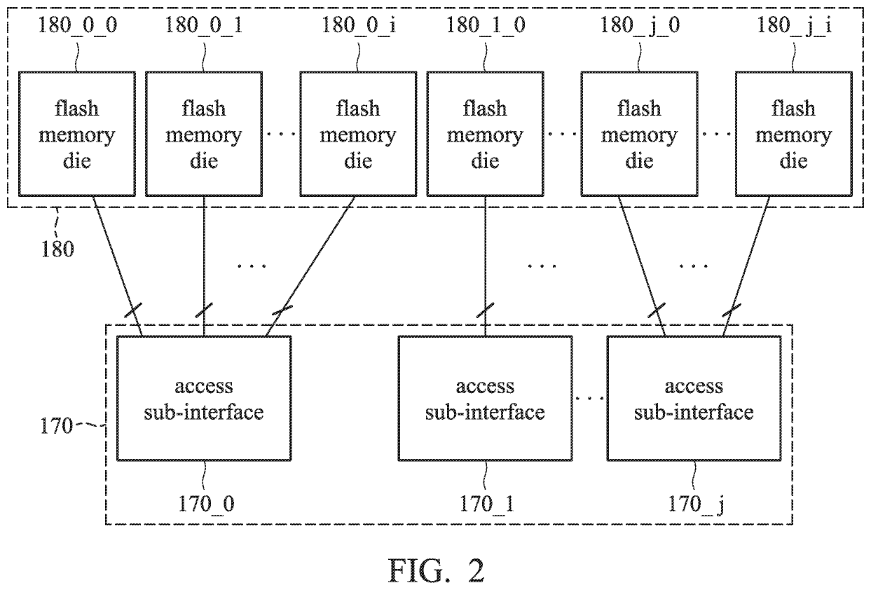

FIG. 2 is a schematic diagram illustrating access interfaces and storage units in accordance with an embodiment of the invention.

The data storage device 140 may contain j+1 access sub-interfaces 170_0 to 170_j, where the access sub-interfaces may be referred to as channels, and each access sub-interface connects to i+1 flash memory dies. That is, i+1 flash memory dies may share the same access sub-interface. For example, assume that the flash memory contains 4 channels (j=3) and each channel connects to 4 storage sub-units (i=3): The flash memory 10 has 16 flash memory dies 180_0_0 to 180_j_i in total. The processing unit 110 may direct one of the access sub-interfaces 170_0 to 170_j to read data from the designated flash memory die. Each flash memory die has an independent CE control signal.

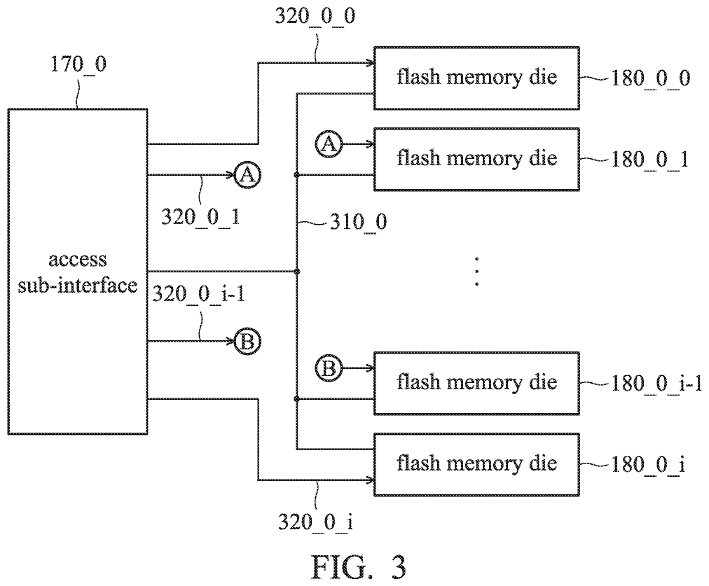

That is, it is required to enable a corresponding CE control signal when attempting to perform data read from a designated flash memory die via an associated access sub-interface. FIG. 3 is a schematic diagram depicting connections between one access sub-interface and multiple flash memory dies according to an embodiment of the invention. The processing unit 162, through the access sub-interface 170_0, may use independent CE control signals 320_0_0 to 320_0_i to select one of the connected flash memory dies 180_0_0 and 180_0_i, and then read data from the designated location of the selected flash memory die via the shared data line 310_0.

In an embodiment, when the data storage device 140 is operating, the memory controller 160 may build and update the logical-to-physical mapping (L2P) table. The L2P mapping table records mapping relationships from logical addresses to the physical space, and is stored in the flash translation layer (FTL) 181 in the flash memory 180 of the data storage device 140. In some embodiments, the data storage device 140 is merely equipped with a small-capacity DRAM 190 (i.e., can be regarded as “partial DRAM”). Alternatively the data storage device 140 is not equipped with the DRAM 190 but uses a host memory buffer (HMB) instead. Accordingly, the entire L2P mapping table cannot be loaded into the DRAM 190 or the HMB. In this situation, the memory controller 160 only loads a portion of the L2P mapping table to the DRAM 190, SRAM 166, or HMB.

A logical address is preferably a logical block address (LBA) which corresponds to 512 bits of user data (i.e., abbreviated as “data”). In some other embodiments, the logical address may be a global host page (GHP) which corresponds to 4K bytes or 16K bytes of data. For brevity, the logical address will be the LBA in the following sections, but the invention is not limited thereto.

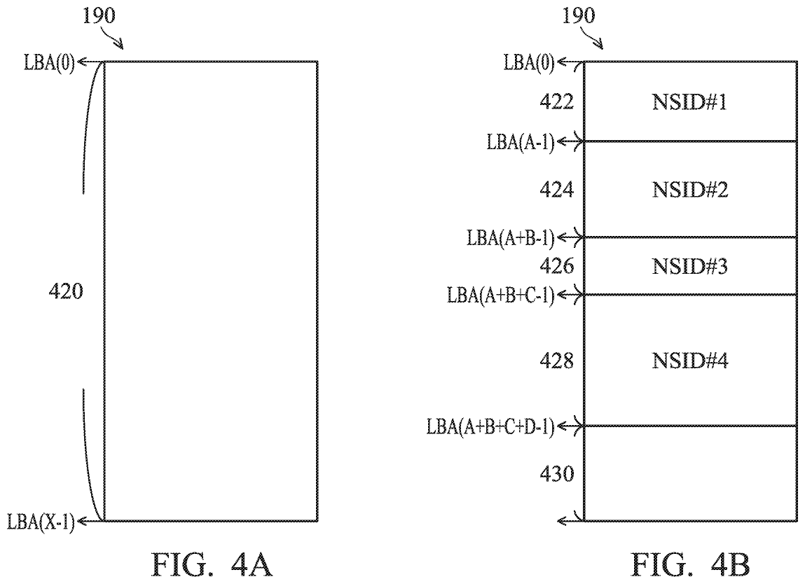

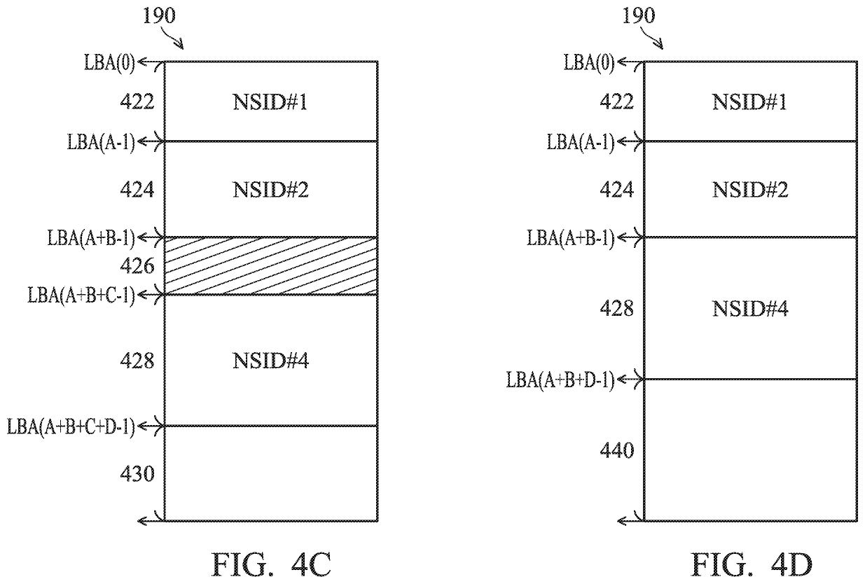

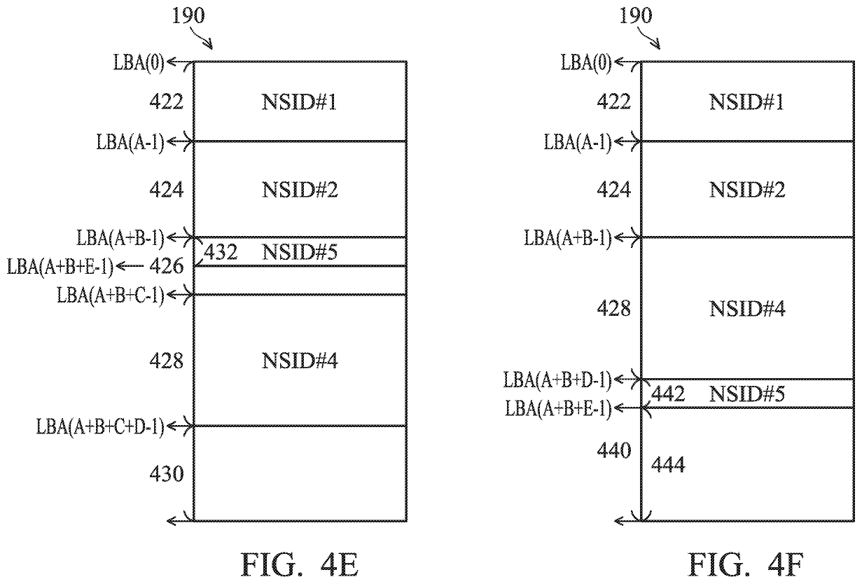

FIGS. 4A-4C are diagrams of the L2P mapping table in accordance with an embodiment of the invention. For purposes of description, in the following embodiments, the memory controller 160 may load the entire L2P mapping table or a portion of it to the DRAM 190, and perform a corresponding operation to the namespace mapping tables in the L2P mapping table according to the namespace operation command (e.g., a namespace-creating command or a namespace-deleting command) from the host 120.

In an embodiment, it is assumed that the host 120 does not create any namespaces in the data storage device 140 or it is assumed that the number of namespaces is equal to 1. The storage space (or the maximum storage space) of the data storage device 140 can be used to store X pieces of user data, where each piece of user data corresponds to an LBA. The logical-address range 420 starts from LBA(0) to LBA(X−1), where LBA(0) denotes the starting logical address, and LBA(X−1) denotes the ending logical address, as depicted in FIG. 4A. The logical addresses in the logical-address range 420 are preferably continuous. If the logical addresses in the logical-address range 420 are discontinuous, the number of logical addresses in the logical-address range 420 is smaller than the value X.

When the host 120 issues a namespace-creating command to the data storage device 140 to create a new namespace in the data storage device 140, each namespace has an individual namespace identifier. For example, namespace identifiers ID #1, ID #2, ID #3, and ID #4 correspond to namespaces NSID #1, NSID #2, NSID #3, and NSID #4, respectively. After receiving the namespace-creating command, the memory controller 160 may create a new namespace according to the total number of LBAs. For example, the namespace NSID #1 has a logical-address range 422 whose number of LBAs is value A; the namespace NSID #2 has a logical-address range 424 whose number of LBAs is value B; the namespace NSID #3 has a logical-address range 426 whose number of LBAs is value C; the namespace NSID #4 has a logical-address range 428 whose number of LBAs is value D. The value A plus B plus C plus D is smaller than or equal to the value X. The starting logical address of each namespace NSID is preferably LBA(0). In addition, the data storage device 140 may still have some unused storage space, as shown by the remaining logical-address range 430 in FIG. 4B. In addition, the namespaces NSID #1˜NSID #4 correspond to different physical spaces in the flash memory 180.

Since each namespace NSID operates independently, in order to manage the namespaces NSID #1, NSID #2, NSID #3, and NSID #4, the memory controller 160 needs to establish four L2P mapping tables such as L2P #1, L2P #2, L2P #3, and L2P #4 to manage data stored in the namespaces NSID #1, NSID #2, NSID #3, and NSID #4, respectively.

How to efficiently and correctly manage multiple namespace has always been an important and troublesome technical issue. In the present invention, the memory controller 160 may build a global L2P mapping table to manage the data stored in the namespaces NSID #1, NSID #2, NSID #3, and NSID #4, and the logical-address ranges of the namespaces NSID #1˜NSID #4 are adjacent in an order. As shown in FIG. 4B, the logical-address range 422 is from LBA(0) to LBA(A−1); the logical-address range 424 is from LBA(A) to LBA(A+B−1); the logical-address range 426 is from LBA(A+B) to LBA(A+B+C−1); the logical-address range 428 is from LBA(A+B+C) to LBA(A+B+C+D−1). The memory controller 160 may determine the namespace to be accessed by the host command according to the namespace identifier ID #1, ID #2, ID #3, and #4 indicated in the host command, and maps the LBA indicated in the host command to the logical-address range of the accessed namespace. For example, the host command may be a read command including the namespace identifier ID #2 and LBA #100, and the memory controller 160 may convert the LBA #100 in the host command to LBA #(A+100) in the logical-address range 424 of the namespace NSID #2, and obtain the physical address corresponding to LBA #100 by referring to the content in the global L2P mapping table. The memory controller 160 may retrieve the content stored in the physical address and transfer the retrieved content to the host 120 to respond the host command. As such, the memory controller 160 may efficiently and correctly manage multiple namespaces according to the global L2P mapping table.

When the host 120 writes data to a specific namespace or deletes data from the specific namespace, mapping relationships from logical addresses to physical addresses recorded by the global L2P mapping table is also updated. The memory controller 160 preferably uploads the global L2P mapping table to the DRAM 190 or HMB, and writes the updated global L2P mapping table into the flash memory 180 at an appropriate time.

In addition to establishing a namespace, the host 120 may also perform a namespace-related operation such as deleting an existing namespace. For example, when the host 120 transmits a namespace-operation command to the data storage device 140 to delete the namespace NSID #3, since the namespace NSID #3 corresponds to the logical-address range 426, the memory controller 160 will delete the mapping relationships recorded in the logical-address range 426 in the global L2P mapping table, as depicted in FIG. 4C. In order to simplify the management of the global L2P mapping table, the logical-address range 426 will not be used after deletion or trimming. Afterwards, if a new namespace is to be created, the remaining logical-address range 430 will be used first. As can be seen from the above, after repeatedly creating namespaces and deleting namespaces, the remaining logical-address range 430 is quickly consumed or used, and it will cause the data storage device 140 to have data storage capability, but the host 120 cannot to create a new namespace NSID. Accordingly, how to delete namespaces efficiently and correctly is an important and troublesome technical issue.

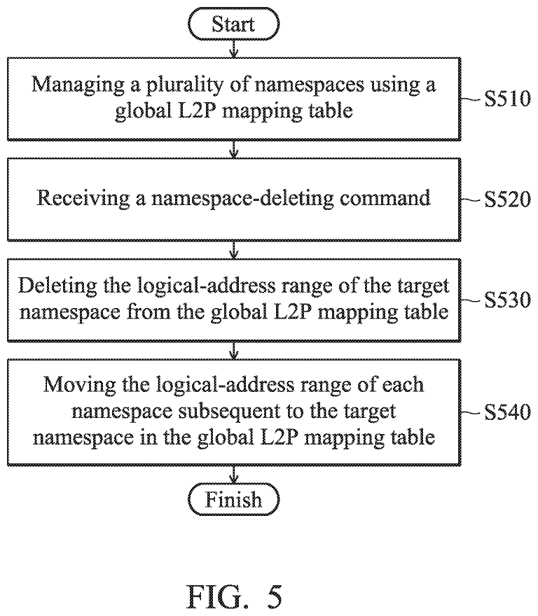

FIG. 5 is a flow chart of a method of deleting namespaces in accordance with an embodiment of the invention. In step S510, the memory controller 160 manages a plurality of namespaces using a global L2P mapping table. For example, under the condition of FIG. 4A, the memory controller 160 has created namespaces NSID #1, NSID #2, NSID #3, and NSID #4, as depicted in FIG. 4B, and manages the mapping relationships between logical addresses and physical addresses corresponding to the namespaces NSID #1, NSID #2, NSID #3, and NSID #4 using the global L2P mapping table.

In step S520, the memory controller 160 receives a namespace-deleting command, wherein the namespace-deleting command is from the host 120. In addition, the target namespace indicated by the namespace-deleting command is one of the namespaces that is not the last namespace of the sequentially arranged namespaces, such as namespace NSID #3.

In step S530, the memory controller 160 deletes the logical-address range of the target namespace from the global L2P mapping table. For example, the logical-address range corresponding to the namespace NSID #3 is from LBA(A+B) to LBA(A+B+C−1). Accordingly, the memory controller 160 deletes the mapping relationships recorded by the logical-address range from LBA(A+B) to LBA(A+B+C−1), as depicted in FIG. 4C.

In step S540, the memory controller 160 moves the logical-address range of all namespaces subsequent to the target namespace in the global L2P mapping table. For example, the namespace subsequent to the target namespace NSID #3 is the namespace NSID #4. The memory controller 160 moves or copies the logical-address range 428 corresponding to the namespace NSID #4 in the global L2P mapping table to the logical-address range 426. That is, the mapping relationships recorded in LBA(A+B+C) to LBA(A+B+C+D−1) are copied to LBA(A+B) to LBA(A+B+D−1), and then the mapping relationships recorded in LBA(A+B+D) to LBA(A+B+C+D−1) are deleted, as depicted in FIG. 4D, thereby updating the global L2P mapping table. Accordingly, the logical-address range corresponding to the namespaces NSID #1, NSID #2, and NSID #4 are adjacent to each other. Since the logical-address range 428 of the namespace NSID #4 is moved forward to fill the logical-address range 426 corresponding to the namespace NSID #3 that was deleted, the remaining logical-address range 430 (i.e., unused storage space) is increased (i.e., enlarged) to the remaining logical-address range 440. Subsequently, if the host 120 is to create a new namespace NSID #5, the memory controller 160 may create the logical-address range corresponding to the new namespace NSID #5 within the remaining logical-address range 440, such as the logical-address range corresponding to the namespace NSID #5 starting from the starting logical address of the remaining logical-address range 440.

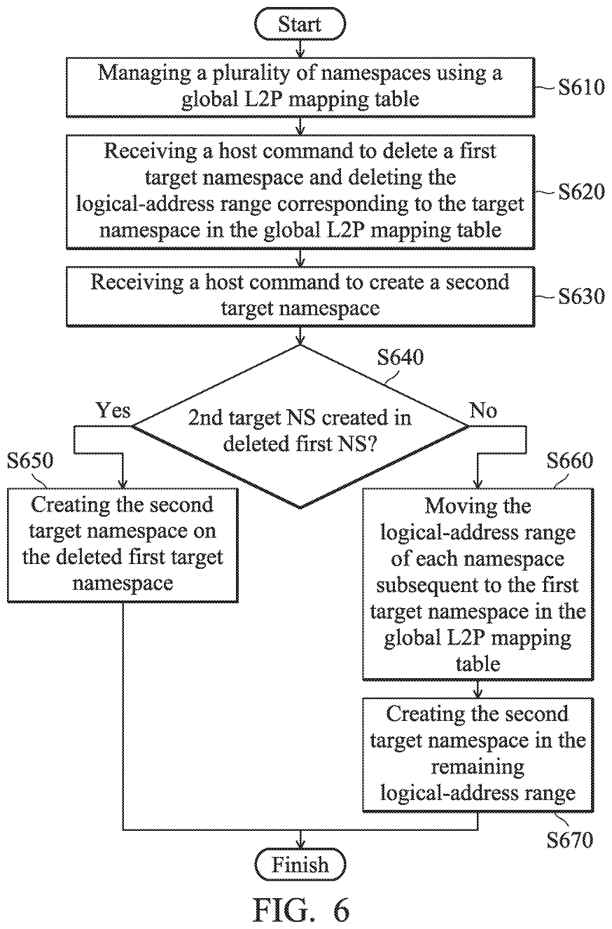

FIG. 6 is a flow chart of a method of creating a namespace in accordance with an embodiment of the invention. In step S610, the memory controller 160 manages a plurality of namespaces using a global L2P mapping table. For example, under the condition of FIG. 4A, the memory controller 160 has created namespaces NSID #1, NSID #2, NSID #3, and NSID #4, as depicted in FIG. 4B, and manages the mapping relationships between logical addresses and physical addresses corresponding to the namespaces NSID #1, NSID #2, NSID #3, and NSID #4 using the global L2P mapping table.

In step S620, the memory controller 160 receives a host command to delete a target namespace (e.g., a first target namespace), and deletes the logical-address range corresponding to the target namespace in the global L2P mapping table. Since step S620 is similar to steps S520 and S530 in FIG. 5, and the deleted target namespace is also namespace NSID #3, the details will be omitted here.

In step S630, the memory controller 160 receives a host command to create another target namespace (e.g., a second target namespace), wherein the host command is from the host 120, and the target namespace is a new namespace such as the namespace NSID #5.

In step S640, the memory controller 160 determines whether the target namespace can be built on the deleted namespace. If the target namespace can be built on the deleted namespace, step S650 is performed. If the target namespace cannot be built on the deleted namespace, step S660 is performed. The logical-address range 426 corresponding to the namespace NSID #3 is from LBA(A+B) to LBA(A+B+C−1), and the number of logical addresses in the namespace NSID #3 is equal to C. Assuming that the number of logical addresses in the namespace NSID #5 indicated by the host command in step S630 is equal to E and E is smaller than or equal to C, it indicates that the size of the namespace NSID #5 is smaller than or equal to that of the original namespace NSID #3. Thus, the memory controller 160 is capable of creating the namespace NSID #5 in the original logical-address range corresponding to the original namespace NSID #3. Conversely, if the value E is greater than the value C, it indicates that the size of the namespace NSID #5 is larger than that of the original namespace NSID #3, and thus the memory controller 160 is not capable of creating the namespace NSID #5 in the logical-address range corresponding to the original namespace NSID #3.

In step S650, the memory controller 160 creates the target namespace on the deleted namespace. The memory controller 160 may create the new target namespace NSID #5 to be adjacent to the namespace NSID #2, and the logical-address range 432 of the namespace NSID #5 has a starting logical address LBA(A+B) and an ending logical address LBA(A+B+E−1), as depicted in FIG. 4E, thereby completing the creation of the target namespace. Meanwhile, the remaining logical-address range may include the original remaining logical-address range 430 plus the new remaining logical-address range 434.

In step S660, the memory controller 160 moves the logical-address range of all namespaces subsequent to the target namespace in the global L2P mapping table. Since step S660 is similar to step S540 in FIG. 5, the details will not be repeated here. As a result, the remaining logical-address range 440 is generated.

In step S670, the memory controller 160 creates the target namespace in the remaining logical-address range. Since the last built namespace is the namespace NSID #4, the memory controller 160 may create the new namespace NSID #5 to be adjacent to the namespace NSID #4, and the logical-address range 442 corresponding to the namespace NSID #5 has a starting logical address LBA(A+B+D) and an ending logical address LBA(A+B+E−1), as depicted in FIG. 4F, thereby completing the creation of the target namespace. The remaining logical-address range 440 is changed (i.e., reduced) to the remaining logical-address range 444.

In view of the above, a data storage device, a method of deleting a namespace, and a method of creating a namespace are provided in the invention. The data storage device and methods are capable of quickly deleting or creating a namespace without wasting any storage space of the data storage device, thereby achieving the purpose of the invention. In addition, the memory controller 160 is capable of managing the namespace mapping table in a more efficient manner, thereby improving the performance of the data storage device 140 and shortening the function verification time when designing the firmware or code of the activation program 164.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory; and
a memory controller, configured to manage a global logical-to-physical (L2P) mapping table of the flash memory, wherein the global L2P table comprises a plurality of namespaces, and the namespaces correspond to a plurality of physical spaces in the flash memory,
wherein in response to the memory controller receiving a namespace-deleting command from a host, the memory controller deletes a target namespace from the namespaces and deletes a first logical-address range corresponding to the target namespace from the global L2P table;
wherein the memory controller further moves a second logical-address range corresponding to all of the namespaces subsequent to the target namespace in the global L2P mapping table to update the global L2P mapping table.

2. The data storage device as claimed in claim 1, wherein in response to the memory controller receiving an access command from the host, the memory controller calculates a logical address in the global L2P table corresponding to the access command according to a namespace identifier of one of the namespaces and a corresponding access logical address indicated in the access command.

3. The data storage device as claimed in claim 2, wherein after the global L2P table has been updated, and in response the data storage device receiving a namespace-creating command from the host to create a first namespace, the memory controller creates the first namespace being subsequent to the logical-address range of the last namespace in the updated global L2P table according to the namespace-creating command.

4. The data storage device as claimed in claim 1, wherein the memory controller reads the global L2P mapping table from the flash memory into a volatile memory, deletes the logical-address range corresponding to the target namespace from the global L2P table stored in the volatile memory according to the namespace-deleting command, and moves forward each namespace subsequent to the target namespace in the global L2P mapping table to fill the logical-address range of the deleted target namespace to update the global L2P mapping table,
wherein the memory controller further writes the updated global L2P mapping table into the flash memory.

5. A method of deleting a namespace, for use in a data storage device, wherein the data storage device comprises a flash memory, the method comprising:
managing a global logical-to-physical (L2P) mapping table of the flash memory, wherein the global L2P table comprises a plurality of namespaces, and the namespaces correspond to a plurality of physical spaces in the flash memory;
receiving a namespace-deleting command from a host;
deleting a target namespace from the plurality of namespaces and deleting a first logical-address range corresponding to the target namespace from the global L2P table; and
moving a second logical-address range corresponding to each namespace subsequent to the target namespace in the global L2P mapping table to update the global L2P mapping table.

6. The method as claimed in claim 5, further comprising:
in response to the data storage device receiving an access command from the host, calculating a logical address in the global L2P table corresponding to the access command according to a namespace identifier of one of the namespace and a corresponding access logical address indicated in the access command.

7. The method as claimed in claim 6, wherein after updating the global L2P mapping table, the method further comprises:
in response the data storage device receiving a namespace-creating command from the host to create a first namespace, creating the first namespace to be subsequent to the logical-address range of the last namespace in the updated global L2P table according to the namespace-creating command.

8. The method as claimed in claim 5, further comprising:
loading the global L2P mapping table from the flash memory into a volatile memory;
deleting the logical-address range corresponding to the target namespace from the global L2P table stored in the volatile memory according to the namespace-deleting command;
moving forward each namespace subsequent to the target namespace in the global L2P mapping table to fill the logical-address range of the deleted target namespace to update the global L2P mapping table; and
writing the updated global L2P mapping table into the flash memory.

9. A data storage device, comprising:
a flash memory; and
a memory controller, configured to manage a global logical-to-physical (L2P) mapping table of the flash memory, wherein the global L2P table comprises a plurality of namespaces, and the namespaces correspond to a plurality of physical spaces in the flash memory,
wherein in response to the memory controller receiving a namespace-deleting command from a host, the memory controller deletes a first target namespace from the namespaces and deletes a first logical-address range corresponding to the target namespace in the global L2P table,
wherein in response to the memory controller receiving a namespace-creating command from the host to create a second target namespace, the memory controller further determines whether the second target namespace can be created in the first logical-address range corresponding to the first target namespace,
wherein in response to the memory controller determining that the second target namespace cannot be created in the first logical-address range corresponding to the first target namespace, the memory controller moves a second logical-address range of each namespace subsequent to the first target namespace in the global L2P mapping table to update the global L2P mapping table, and creates the second target namespace in a remaining logical-address range in the updated global L2P mapping table.

10. The data storage device as claimed in claim 9, wherein the memory controller reads the global L2P mapping table from the flash memory into a volatile memory, deletes the first logical-address range corresponding to the first target namespace from the global L2P table stored in the volatile memory according to the namespace-deleting command, and moves forward each namespace subsequent to the first target namespace in the global L2P mapping table to fill the first logical-address range of the deleted first target namespace to update the global L2P mapping table,
wherein the memory controller further creates the second target namespace in the remaining logical-address range of the updated global L2P mapping table, and the second target namespace is subsequent to the logical-address range of the last namespace in the updated global L2P mapping table.
